(19) United States
(12) Patent Application Publication
(10) Pub. No.: US 2026/0343422 A1
(43) Pub. Date: Oct. 29, 2026

(54) TRANSMIT POWER MANAGEMENT USING SENSOR DATA

(71) Applicant: Lenovo (Beijing) Limited, Beijing (CN)

(72) Inventors: Xuyuan Pan, Chicago, IL (US); Kangkang Chen, Shanghai (CN); Junsheng Zhao, Vernon Hills, IL (US); Md Faisal Abedin, Lisle, IL (US)

(73) Assignee: Lenovo (Beijing) Limited, Beijing (CN)

(21) Appl. No.: 19/373,168

(22) Filed: Oct. 29, 2025

Related U.S. Application Data
(63) Continuation of application No. PCT/CN2025/090657, filed on Apr. 23, 2025.

(51) Int. Cl. H04W 52/18; H04M 1/02

(52) U.S. Cl. CPC H04W 52/18; H04M 1/0216

(57) ABSTRACT

In aspects of transmit power management using sensor data, a device including a first housing and a second housing foldably coupled with the first housing detects a change in sensor data at one or more of the first housing or the second housing. The device detects the change in the sensor data using a first sensor of the first housing and a second sensor of the second housing. The device determines a transmit power for one or more antennas of the first housing or of the second housing based on the change in the sensor data satisfying a threshold value. For example, the device reduces a transmit power for antennas of the first housing and/or the second housing based on the change in the sensor data satisfying the threshold value. The device transmits signaling using the transmit power for the one or more antennas.

### RELATED APPLICATION

This application claims priority benefit of Application Number PCT/CN2025/090657 filed 23 Apr. 2025 entitled “Transmit Power Management Using Sensor Data,” the disclosure of which is incorporated by reference herein in its entirety.

### BACKGROUND

Devices, such as smart devices, mobile devices (e.g., cellular phones, tablet devices, smartphones), consumer electronics, and the like, can be implemented for use in a wide range of environments and for a variety of different applications. The devices can include and/or can implement one or more sensors to detect environmental conditions and user interactions with the devices. In some examples, the devices can include multiple housings (e.g., different sections of the devices) that can be folded, where a device with the multiple housings can be referred to as a foldable device. For example, a foldable device can include a display that is configured to be used as a single display or is configured to be folded and used as multiple separate displays or a single relatively small display.

### BRIEF DESCRIPTION OF THE DRAWINGS

Implementations of the techniques for transmit power management using sensor data are described with reference to the following Figures. The same numbers may be used throughout to reference like features and components shown in the Figures:

FIG. 1 illustrates an example system for transmit power management using sensor data in accordance with one or more implementations as described herein.

FIG. 2 illustrates an example of a foldable mobile device for transmit power management using sensor data in accordance with one or more implementations as described herein.

FIG. 3 illustrates an example environment for transmit power management using sensor data in accordance with one or more implementations as described herein.

FIG. 4 illustrates an example sensor diagram for transmit power management using sensor data in accordance with one or more implementations as described herein.

FIG. 5 illustrates an example flowchart for transmit power management using sensor data in accordance with one or more implementations as described herein.

FIGS. 6 and 7 illustrate examples of methods for transmit power management using sensor data in accordance with one or more implementations of the techniques described herein.

FIG. 8 illustrates various components of an example device that can be used to implement the techniques for transmit power management using sensor data as described herein.

### DETAILED DESCRIPTION

Implementations of techniques for transmit power management using sensor data are described herein. In some examples, a device (e.g., a mobile device, including a foldable device, or any other wireless communication device) can implement one or more sensors to detect a proximity of a user. The device can implement capacitor sensors in multiple housings (e.g., for a foldable device) to determine whether respective housings of the device are within a threshold distance from the user, including within a threshold distance from human tissue or other surfaces related to the user. The sensors provide sensor data that the device can use to dynamically adjust a transmit power of one or more antennas of the respective housings to comply with (e.g., satisfy) a maximum permissible exposure to electromagnetic radiation caused by signaling. The device can transmit signaling using the dynamically adjusted transmit power.

Conventional techniques for managing transmit power at a device may not distinguish between proximity of a user to different housings (e.g., front or back surfaces, portions) of the device. For example, the device can use one or more non-directional sensor to detect proximity of the device to the user. However, the device may not be able to determine which side of the device (e.g., which housing or portion of a foldable device) is facing the user. The device can also use a directional sensor (e.g., a camera) to determine which side of the device is facing the user. However, using a directional sensor to determine which side of the device is facing the user leads to inefficient use of power resources and introduces latency when compared with non-directional sensing. Thus, conventional techniques for managing transmit power include the device reducing a transmit power for antennas at each of the sides of the device (e.g., each of the housings, antennas located at both the front and the back of the device) regardless of which side of the device is facing the user. Reducing transmit power for antennas regardless of which side of the device is facing the user reduces or degrades the signal quality of signaling to and from the device, as well as increases signaling overhead and inefficient resource use at the device related to retransmission of the signaling caused by the degraded signal quality.

As described herein, a device with multiple foldable housings implements sensors (e.g., non-directional sensors, capacitor sensors) in each housing to detect proximity to human tissue and/or other surfaces. The device can include a front housing and/or a back housing, where the device has two housings. Additionally, or alternatively, the device can have more than two housings. The device uses data from the sensors to determine a housing that is closest to human tissue, including a body of a user. The device can selectively (e.g., dynamically) adjust a transmit power for antennas in different housings to comply with a maximum permissible exposure to electromagnetic radiation caused by wireless communications, while maintaining signal quality. The device can transmit signaling using the transmit power for the antennas. In some cases, the device can identify that a surface (e.g., a front or a back surface) of the device is in contact with a user, which is referred to as a body-worn use case for the device, prior to adjusting the transmit power for the antennas.

By using multiple non-directional sensors to dynamically adjust the transmit power for the antennas, the device can reduce or prevent unnecessary reduction of transmit power at one or more antennas. For example, the device can use sensor data from the sensors to distinguish between proximity of the user to different housings of the device and adapt the transmit power at antennas of the different housings to account for different folding configurations of the device. The described techniques enable the device to maintain or improve wireless performance, while satisfying safety standards (e.g., maximum permissible exposure) across various use cases and configurations of the device.

While features and concepts of the described techniques for transmit power management using sensor data can be implemented in any number of different devices, systems, environments, and/or configurations, implementations of the techniques for transmit power management using sensor data are described in the context of the following example devices, environments, sensor diagrams, systems, flowcharts, and methods.

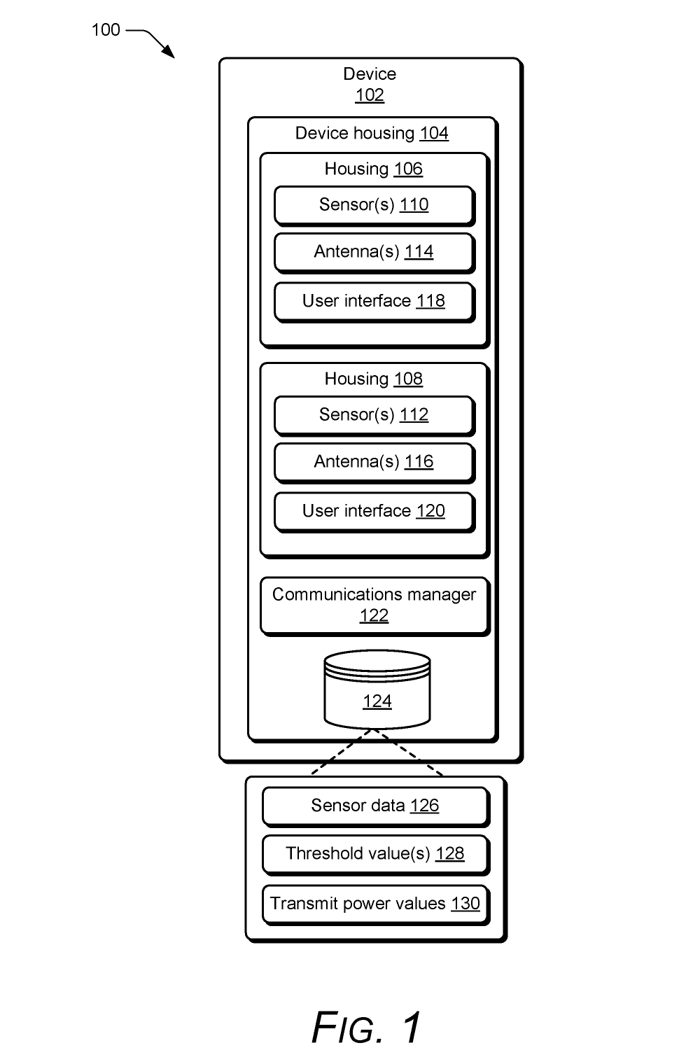

FIG. 1 illustrates an example system 100 for transmit power management using sensor data, as described herein. The example system 100 includes a device 102, which may be communicatively coupled with one or more other devices (e.g., via a network). The device 102 may exchange signaling, including control signaling and/or data, with one or more other devices via a wireless communications link in the network (e.g., a cellular network, a Wi-Fi network, or another wireless network). The device 102 may range from a full resource device or system with substantial memory and processor resources to a low-resource device or system with reduced memory and processing resources. Although in instances in the following discussion reference is made to a device 102 in the singular, the device 102 may be representative of multiple different devices or systems. The device 102 may include one or more features in addition to, or as an alternative to, the features in the system 100.

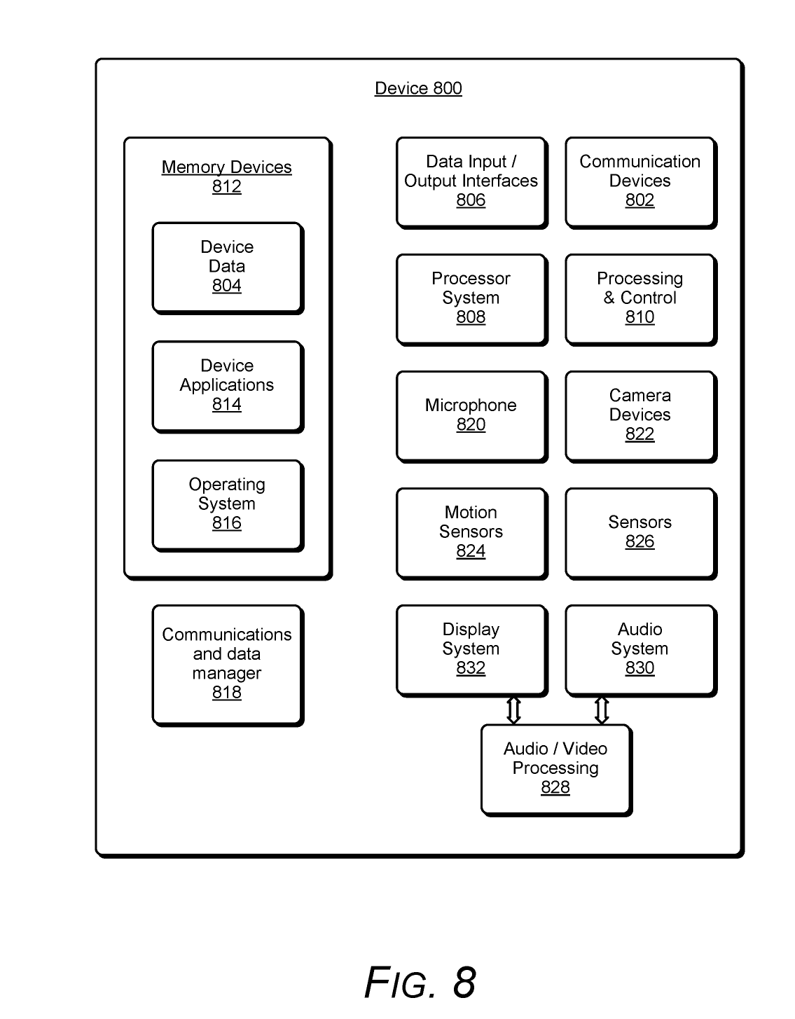

In some examples, the device 102 is an example of a user equipment (UE), a smartphone, a mobile phone, a wearable device, and/or any other type of wireless device or mobile device. The device 102 can be implemented with various components, such as a processor system and memory, as well as any number and combination of different components as further described with reference to the example device shown in FIG. 8. The device 102 may be a foldable device, which refers to a device with multiple housings that can be folded relative to one another. Example foldable devices include, but are not limited to, smartphones with foldable displays (e.g., displays that rotate or hinge relative to one another), laptops with hinges that provide for rotation of the display and/or the keyboard, tablets with detachable keyboards, or multi-fold devices with two or more housings.

The device 102 can include a device housing 104, which may be divided into multiple portions or housings. For example, the device housing 104 may include, but is not limited to, a housing 106 and a housing 108. The housing 106 may be foldably coupled with the housing 108, in that the housing 106 and the housing 108 are connected by a hinge or flexible joint that provides for the housing 106 and the housing 108 to fold together (e.g., such that one or more edges or surfaces of the housings are touching) or apart (e.g., such that a single edge or fewer of the housings is touching). The device 102 can include any number of housings and foldable configurations, such as dual-screen devices, flip phones, or multi-fold designs that fold more than once.

The housing 106 can include one or more sensors 110, and the housing 108 can include one or more sensors 112. The sensors 110 and the sensors 112 may include, but are not limited to, capacitor sensors, proximity sensors, accelerometers, gyroscopes, or other types of sensors capable of detecting an orientation of the device 102, movement of the device 102, or proximity of the device 102 (e.g., the housing 106 and/or the housing 108) to surfaces or human tissue. For example, capacitor sensors in the housing 106 and in the housing 108 can detect changes in capacitance when near (e.g., within a threshold distance from or proximity to) a user. The capacitor sensors measure capacitance values that change when human tissue or other surfaces come within a detection distance (e.g., within 5 millimeters or another predetermined or defined distance threshold).

The housing 106 can include one or more antennas 114, and the housing 108 can include one or more antennas 116. The antennas 114 and the antennas 116 are components for wireless communication, which may include cellular antennas, Wi-Fi antennas, Bluetooth antennas, or near-field communication antennas, among other examples. The antennas 114 and the antennas 116 enable the device 102 to transmit and receive wireless signals (e.g., signaling, messages). In a foldable device, antennas may be distributed across different housings, including the housing 106 and the housing 108 at the device 102, to provide for connectivity regardless of a folded state of the device 102. The device 102 may manage a transmit power of the antennas 114 and the antennas 116 to comply with a maximum permissible exposure for electromagnetic radiation (e.g., when the device 102 is within a threshold distance or proximity to human tissue in body-worn use cases). Maximum permissible exposure to electromagnetic radiation may refer to a highest level of electromagnetic energy that a person can be safely exposed to without experiencing adverse health effects. The device 102 may determine and/or receive an indication of maximum permissible exposure values based on factors, such as frequency bands used for transmission, device form factor, and applicable regulatory standards. In some cases, the device 102 may store predefined maximum permissible exposure threshold values for different frequency ranges and usage scenarios. Additionally, or alternatively, the device 102 may dynamically calculate maximum permissible exposure values based on real-time operating parameters, such as transmission frequency, antenna configuration, and detected proximity to the user.

The housing 106 can include a user interface 118, and the housing 108 can include the user interface 120. The user interface 118 and the user interface 120 provide for user interaction with the device 102. The user interface 118 and the user interface 120 may include touchscreens, physical buttons, voice recognition systems, or gesture controls, among other examples. For a foldable device, different user interfaces may be active depending on a folded state of the foldable device. For example, when fully folded, a smaller external display may be active, while unfolding the device might activate a larger internal display spanning multiple housings.

The communications manager 122 at the device 102 controls wireless communications and transmit power. The communications manager 122 processes data from the sensors 110 and the sensors 112 to determine a proximity of the device 102 to the user or surfaces. Based on the proximity of the device 102, the communications manager 122 adjusts a transmit power of the antennas 114 and the antennas 116 to maintain signal quality, while complying with a maximum permissible exposure. The communications manager 122 handles the transmission of signaling using the adjusted transmit power levels. The communications manager 122 can determine if the device 102 is in a body-worn use case, such as when multiple edges of the device are in contact with a user, before detecting whether different housings of the device 102 (e.g., front and back housings, the housing 106 and the housing 108) are within a threshold distance from the user using the sensors 110 and the sensors 112.

The device 102 can include data storage 124. The data storage 124 may include various types of memory, such as solid-state drives, hard disk drives, or removable storage media. In some implementations, the data storage 124 may include volatile memory for temporary data storage and non-volatile memory for long-term data retention. The data storage 124 at the device 102 stores various types of data relevant to transmit power management. For example, the data storage 124 includes, but is not limited to, sensor data 126, one or more threshold values 128, and/or one or more transmit power values 130. The sensors 110 and the sensors 112 may collect (e.g., obtain, determine, measure) the sensor data 126. The sensor data 126 may include, but is not limited to, capacitance values that indicate proximity to human tissue, accelerometer data that indicates device orientation, proximity measurements (e.g., from a camera or other proximity sensors), or temperature readings, among other examples. For capacitor sensors, the data may include measurements that change when human tissue comes within a threshold distance from a housing of the device 102 (e.g., the front or back surface of the device 102). By comparing the capacitance values from sensors in different housings, the device 102 can determine which side of the device 102 (e.g., which housing) is closest to the user. For example, if the capacitor sensor in the housing 106 is triggered while the sensor in the housing 108 is not, then human tissue is closer to the housing 106 than to the housing 108. The device 102 can reduce a transmit power of the antennas 114 of the housing 106 and can maintain or increase a transmit power of the antennas 116 of the housing 108.

The threshold values 128 define the conditions for which the device 102 is to adjust one or more transmit power values 130. For example, the threshold values 128 can define one or more proximity levels or distances indicated by the sensor data 126 that trigger transmit power adjustments. The threshold values 128 may include respective threshold values 128 for individual antennas or may include respective threshold values for groups of antennas. Additionally, or alternatively, the device 102 can set the threshold values 128 for different sensors to account for variations in sensor sensitivity or positioning. The device 102 can derive (e.g., identify, calculate, determine) the threshold values 128 from received maximum permissible exposure values. For example, a network device can transmit or configure the device 102 with one or more maximum permissible exposure values, and the device 102 can set (e.g., configure, select, determine, identify) the threshold values 128 based on the maximum permissible exposure values. The device 102 can determine threshold values 128 using the maximum permissible exposure values, such that the threshold values 128 trigger an adjustment of transmit power if the maximum permissible exposure values are neared and/or met for a user of the device 102. For capacitor sensors, the threshold values 128 can be calibrated to trigger at defined distances (e.g., when human tissue is within approximately 5 millimeters of a housing surface). For example, if capacitance readings exceed (e.g., satisfy, are greater than) a threshold value 128, indicating close proximity to the user, then the device 102 can reduce a transmit power of nearby antennas.

The device 102 can determine (e.g., select, obtain, identify) transmit power values 130 for the one or more antennas 114 and/or for the one or more antennas 116 if the sensor data 126 indicates that the threshold values 128 are exceeded (e.g., satisfied). The transmit power values 130 represent a current and/or potential power settings for each antenna of the device 102. The device 102 may adjust the transmit power values 130 based on the sensor data 126 and the threshold values 128. For example, the device 102 dynamically adjusts the transmit power values 130 according to a proximity of a user (e.g., human tissue) to the housings of the device 102, including the housing 106 and the housing 108. If the sensors 110 at the housing 106 detect that the user is within a threshold distance from the housing 106, while the sensors 112 at the housing 108 do not detect that the user is within the threshold distance from the housing 108, then the device 102 may reduce the transmit power for the antennas 114 at the housing 106 and may maintain (e.g., may not change) or increase the transmit power for the antennas 116 at the housing 108.

In some examples, the communications manager 122 and/or the data storage 124 may be integrated into or part of the housing 106 and/or the housing 108. In some other examples, the communications manager 122 and/or the data storage 124 may be independent of the housing 106 and/or the housing 108.

By using multiple sensors across different housings, the device 102 can accurately determine which part of the device 102 is closest to a user, providing for more precise and selective adjustment of transmit power at antennas of the device 102. The selective adjustment of the transmit power at antennas of the device 102 reduces or prevents unnecessary power reductions that impact signal quality. The communications manager 122 uses the sensor data 126 and the threshold values 128 to enable dynamic and context-aware power management for compliance with safety standards, while maintaining wireless performance across various device configurations and use cases. For example, in a body-worn use case, where the device 102 is placed in a pocket or worn against a body of the user, the device 102 can determine whether the front or back surface is against the user and adjust a transmit power accordingly. The described techniques provide an improvement over conventional techniques that use one or more non-directional sensors or one or more directional sensors to determine which side of the device 102 is facing the user, leading to excessive power reduction.

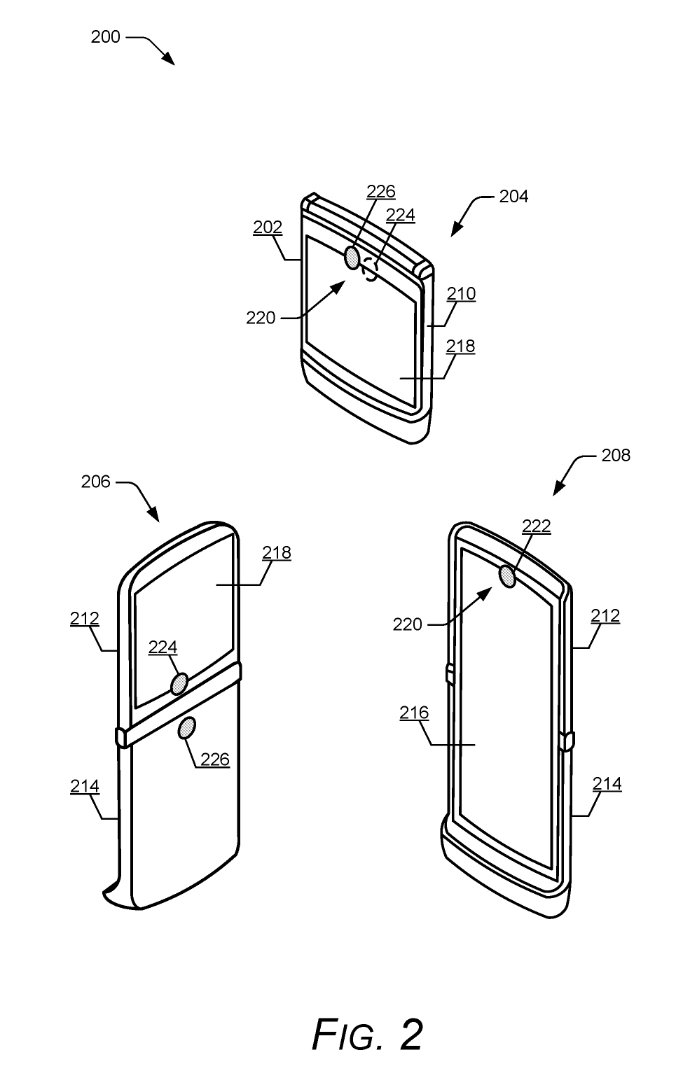

FIG. 2 illustrates an example 200 of a foldable mobile device 202 for transmit power management using sensor data in accordance with one or more implementations as described herein. The foldable mobile device 202 may be an example of the device 102 as described with reference to FIG. 1. Examples of a foldable mobile device or expandable mobile device may include any type of a wireless device, mobile device, mobile phone, flip phone, smartphone, client device, companion device, tablet, communication device, entertainment device, gaming device, media playback device, or any other type of computing, consumer, and/or electronic device. In the example 200, the foldable mobile device 202 is shown in a first view 204 in a folded form factor, and a back of the device is shown in a second view 206 in an opened form factor of the device. A front of the foldable mobile device 202 is also shown in a third view 208 in the opened form factor of the device.

In the example 200, the foldable mobile device 202 has a foldable housing 210, which is operational to fold the device from the opened form factor, as shown in the second view 206 and in the third view 208, to the folded form factor of the device, as shown in the first view 204. The foldable housing 210 of the foldable mobile device 202 includes a first half 212 of the foldable housing and a second half 214 of the foldable housing. Although housing components of the foldable housing 210 are indicated as the first half 212 and the second half 214 of the foldable housing, they may be greater than or less than half of the foldable housing that overlap to form a smaller device. Additionally, or alternatively, the first half 212 of the foldable housing 210 may also be referred to as the top half or the front half of the foldable mobile device 202, while the second half 214 of the foldable housing may also be referred to as the bottom half or back half of the device, given the perspectives shown in the second view 206 and the third view 208 of the foldable mobile device 202.

In some implementations, the foldable mobile device 202 may be a multi-screen device, having two or more display screens. In the example 200, the foldable mobile device 202 includes a relatively large primary display screen 216, and a relatively small secondary display screen 218. The primary display screen 216 may also be referred to as the inner or interior display screen (e.g., or is a two-part display screen), which is folded between the first half 212 and the second half 214 of the foldable housing 210 in the folded form factor of the foldable mobile device 202. The secondary display screen 218 may also be referred to as the outer or exterior display screen, which remains viewable in both the folded form factor of the foldable mobile device 202, as shown in the first view 204 of the device, and in the opened form factor of the foldable mobile device 202, as shown in the second view 206 of the device.

In the example 200, the primary display screen 216 is located on one side (e.g., the front side) of the foldable mobile device 202, as shown in the third view 208, and the secondary display screen 218 is located on the opposite side (e.g., the back side) of the foldable mobile device 202, as shown in the second view 206. The primary display screen 216 and the secondary display screen 218 on the opposite sides of the foldable mobile device 202 may be the same size, approximately the same size, or vary in different sizes. In the example 200, the secondary display screen 218 is smaller than the primary display screen 216 and may be used as a notification screen that displays any type of user interface or notifications associated with device applications on the foldable mobile device 202.

In some implementations, the foldable mobile device 202 in the example 200 includes a sensor system 220. The sensor system 220 may include, but is not limited to, a sensor 222, a sensor 224, and/or a sensor 226. The sensor 222, the sensor 224, and/or the sensor 226 may be capacitor sensors positioned at different locations on the foldable mobile device 202. For example, the sensor 222 may be located near the edge of the primary display screen 216, the sensor 224 may be positioned on the back side of the second half 214, and the sensor 226 may be integrated into the secondary display screen 218. The arrangement of sensors provides for the foldable mobile device 202 to detect proximity to surfaces or human tissue from multiple sides and in various folding configurations. The sensor 222, the sensor 224, and the sensor 226 may operate by measuring changes in capacitance when objects or human tissue come within a threshold distance. For example, the sensor 222 may detect when a user is near the primary display screen 216, while the sensor 224 may determine if the device is being held against the body of the user. The sensor 226 may be used to detect interactions with the secondary display screen 218 when the device is in a folded configuration.

In some examples, the sensor 222, the sensor 224, and the sensor 226 may have different sensitivity levels or detection ranges. For example, the sensor 222 on the primary display screen 216 may have a shorter detection range (e.g., 5 millimeters) to detect proximity, while the sensor 224 on the back may have a longer detection range (e.g., 15 millimeters, to account for clothing or cases). The foldable mobile device 202 may use sensor data from the sensor 222, the sensor 224, and the sensor 226 to determine an orientation of the device and a proximity of different portions of the device to the user. For example, if the sensor 222 and the sensor 224 both detect a proximity of the user is within a threshold value, but the sensor 226 does not, then the device may determine that the device is being held flat against a surface. The device can use the sensor data to adjust the transmit power of antennas located near the sensors within a threshold proximity value to the user. In some implementations, the sensor 222, the sensor 224, and the sensor 226 may include other types of sensors, such as proximity sensors using infrared technology, temperature sensors to detect body heat, and/or pressure-sensitive sensors to detect pressure applied to the device.

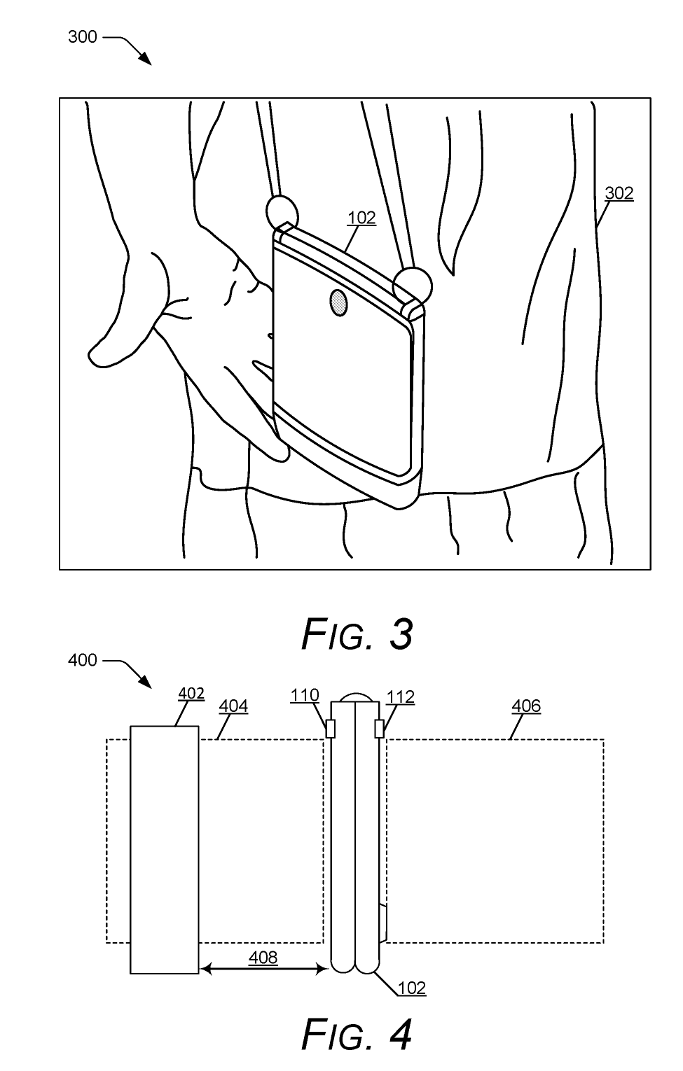

FIG. 3 illustrates an example environment 300 for transmit power management using sensor data in accordance with one or more implementations as described herein. The environment 300 may implement or be implemented by aspects of the example system 100 and the example 200. For example, the environment 300 includes a device 102, which may be an example of the device 102 and/or a foldable mobile device 202 as described with reference to FIGS. 1 and 2.

The environment 300 illustrates an example of a body-worn use case for the device 102. In the environment 300, the device 102 is positioned against a surface 302, which may represent human tissue or a body of a user. The device 102 includes a first housing and a second housing that are foldably coupled. Each housing includes sensors capable of detecting proximity to the surface 302, as described with reference to FIGS. 1 and 2. The first housing of the device 102 is in direct contact with the surface 302, while the second housing is positioned away from the surface 302. The device 102 can use sensors of both housings to determine which housing is closer to the body of the user in a body-worn use case. The device 102 selectively adjusts transmit power for antennas located in different housings based on a relative distance of the housings and corresponding antennas from the user. The device 102 can transmit signaling using the transmit powers. For example, the device 102 can transmit control signaling and/or data to another device in a wireless communications system, such as a mobile device or a network device (e.g., base station). In some cases, the device 102 can report the transmit powers to the other device, and the other device can adjust a transmit power for response signaling, accordingly.

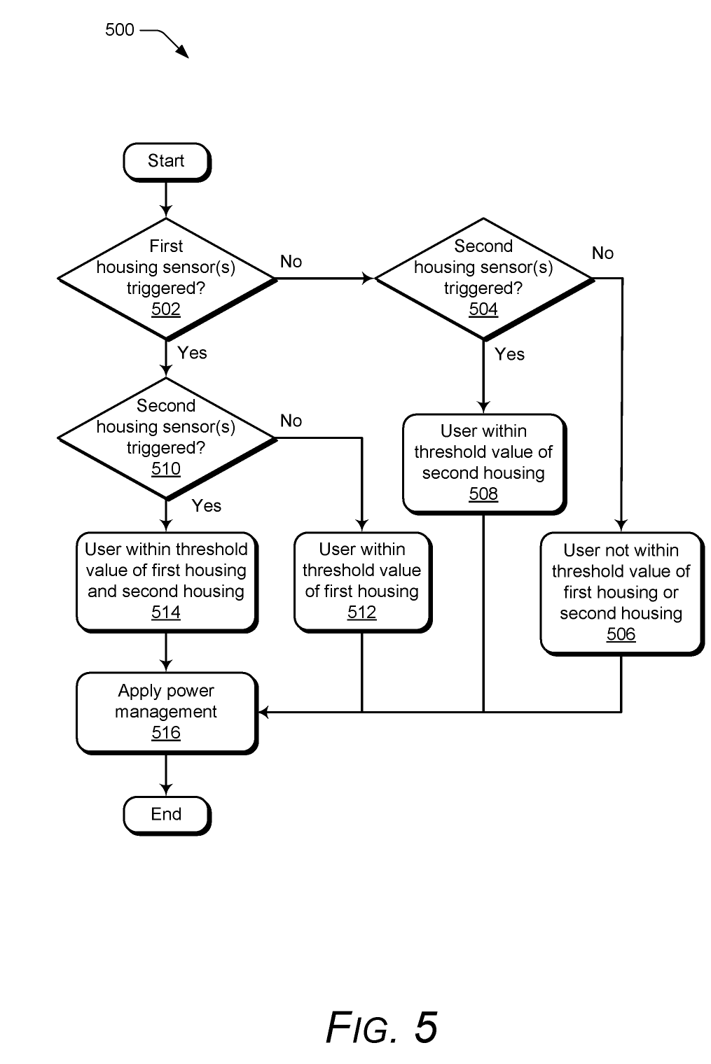

FIG. 4 illustrates an example sensor diagram 400 for transmit power management using sensor data in accordance with one or more implementations as described herein. The sensor diagram 400 may implement or be implemented by aspects of the example system 100, the example 200, and the example environment 300. For example, the sensor diagram 400 depicts a device 102 with one or more sensors 110 of a first housing and one or more sensors 112 of a second housing, which may be an example of the device 102, the sensors 110, and the sensors 112, as described with reference to FIG. 1. Although the sensors 110 are illustrated as a single sensor, the sensors 110 may include any numerical quantity of sensors. Additionally, or alternatively, although the sensors 112 are illustrated as a single sensor, the sensors 112 may include any numerical quantity of sensors.

The device 102 can include multiple sensors, such as the sensors 110 and the sensors 112, positioned in different housings of the device 102. The device 102 uses sensor data collected by the sensors 110 and the sensors 112 to detect a proximity of human tissue 402 to the device 102. The sensors 110 and the sensors 112 may have sensor ranges, including the sensor range 404 and the sensor range 406, respectively. The sensor ranges extend outward from the device 102 towards the human tissue 402.

The device 102 can use the sensors 110 and the sensors 112 to determine which side of the device 102 (e.g., which housing of the device) is within a threshold distance from or proximity to the human tissue 402. For example, the human tissue 402 may be a distance 408 from the sensors 110, where the distance 408 is within the sensor range 404 of the sensors 110. The human tissue 402 may be outside of the sensor range 406 of the sensors 112. If the distance 408 is within the sensor range 404 or a sensor range 406 and/or is within a defined threshold value, then the device 102 can trigger a transmit power adjustment. If the distance 408 is outside of the sensor range 404 and the sensor range 406 and/or is outside of a defined threshold value, then the device 102 may not trigger a transmit power adjustment. The device 102 can compare the distance 408 to one or more threshold values to determine whether to adjust a transmit power for antennas of the housing that includes the sensors 110 (e.g., antennas that are within the threshold value from the human tissue 402). Thus, the device 102 can use sensor data from the sensors 110 and the sensors 112 to detect that the human tissue 402 is within a threshold distance from the housing including the sensors 110 and is not within the threshold distance from the housing including the sensors 112. The device 102 can implement dynamic (e.g., selective, targeted) transmit power management to reduce transmit power for antennas in housings within a threshold distance from the human tissue 402, while maintaining or increasing power for antennas in housings outside of the threshold distance from the human tissue.

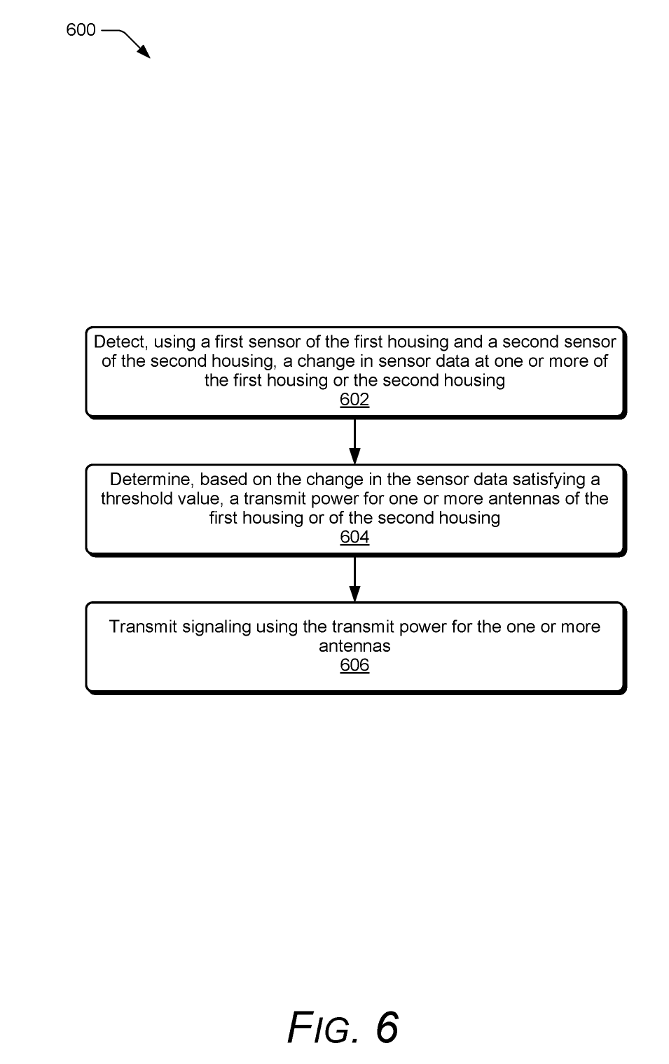

FIG. 5 illustrates an example flowchart 500 for transmit power management using sensor data in accordance with one or more implementations as described herein. The example flowchart 500 may implement aspects of the example system 100, the example 200, the example environment 300, and the example sensor diagram 400. For example, the example flowchart 500 can be implemented by a device, which may be an example of the device 102 and/or a foldable mobile device 202 as described with reference to FIGS. 1 and 2. Alternative examples of the following may be implemented, where some processes are performed in a different order than described or are not performed. In some cases, processes may include additional features not mentioned below, or further processes may be added.

At 502, a determination is made as to whether one or more sensors of a first housing are triggered. For example, the device may determine whether sensors of a first housing of the device (e.g., a foldable mobile device or other foldable device) detect proximity to human tissue or other surfaces. At 504, if the sensors of the first housing are not triggered (e.g., “No”), a determination is made as to whether one or more sensors of the second housing are triggered. For example, the device may determine if sensors in a second housing of the device detect proximity to human tissue or other surfaces. At 506, if the sensors of the second housing are not triggered (e.g., “No”), then a user is not within a threshold value (e.g., a threshold proximity value or a threshold distance value) of the first housing or the second housing.

At 508, if the sensors of the second housing are triggered (e.g., “Yes”), then a user is within a threshold value (e.g., a threshold proximity value or a threshold distance value) of the second housing. For example, the device may compare sensor data from the sensors of the second housing to one or more defined threshold values to determine that a user (e.g., the human tissue or other surfaces) are within a threshold distance or proximity to the second housing.

At 510, if the sensors of the first housing are triggered (e.g., “Yes” at 502), a determination is made as to whether the sensors of the second housing are triggered. For example, the devices determines whether both housings are within a threshold distance or proximity to the user. At 512, if the sensors of the second housing are not triggered (e.g., “No” at 510), then a user is within a threshold value of the first housing. At 514, if both the sensors of the first housing and the sensors of the second housing are triggered (e.g., “Yes” at 510), then a user is within threshold values of both the first housing and second housing.

At 516, after determining a position of a user relative to the housings, power management is applied. For example, the device may adjust transmit power for antennas in the respective housings based on the proximity determinations.

If the sensors in the first housing detect that a user is within a threshold distance, then the device may reduce the transmit power for antennas in the first housing while maintaining or increasing the transmit power for antennas in the second housing. The device may perform the transmit power adjustments for each antenna basis or for groups of antennas (e.g., antennas within each housing or other antenna groupings). In some cases, the device may implement a graduated power reduction scheme, where the transmit power is decreased in steps as the detected proximity to the user decreases. For example, if a user is detected within 5 millimeters of the first housing, then the device may reduce the transmit power of antennas of the first housing by 50%. If the user is detected within 2 millimeters of the first housing, then the device may reduce the transmit power of antennas of the first housing by 75%.

Additionally, or alternatively, the device may perform the transmit power adjustments based on a type of antenna and a location of the antenna within the housing. For example, the device can reduce a transmit power of antennas located closer to the edge of a housing by a greater value when compared with antennas located at or near a center of the housing when user proximity is detected. In some cases, the device may perform the transmit power adjustments based on a current operating mode or based on one or more active applications at the device. For example, if the device is actively engaged in a voice call, then the device may prioritize maintaining a transmit power for antennas used for cellular communication, while reducing transmit power for Wi-Fi or Bluetooth antennas.

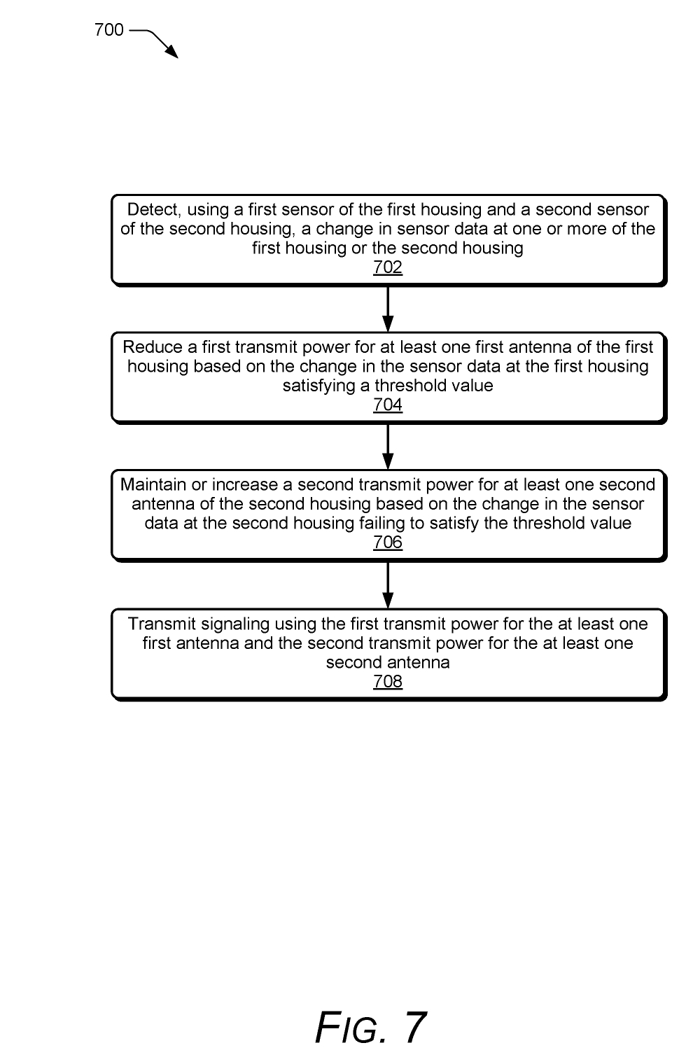

FIG. 6 illustrates an example method 600 for transmit power management using sensor data. The order in which the method is described is not intended to be construed as a limitation, and any number or combination of the described method operations can be performed in any order to perform a method, or an alternate method.

At 602, a device detects a change in sensor data at one or more of the first housing or the second housing using a first sensor of a first housing and a second sensor of a second housing. The device can include a device housing that includes the first housing and the second housing, which is foldably coupled with the first housing. For example, the housings may be foldably coupled by being connected by a hinge or flexible joint that provides for the housings to fold together (e.g., such that one or more edges or surfaces of the housings are touching) or apart (e.g., such that a single edge or fewer of the housings is touching). The first sensor and the second sensor may include capacitor sensors, and the sensor data may include capacitance values that indicate a proximity of human tissue to at least one of the first housing or the second housing.

In some cases, prior to detecting the change in the sensor data, the device detects that a surface of the device is in contact with a user (e.g., the device is in a body-worn use case). Responsive to the surface of the device being in contact with the user, the device obtains the sensor data.

At 604, the device determines a transmit power for one or more antennas of the first housing or of the second housing based on the change in the sensor data satisfying a threshold value. In some cases, the device reduces a first transmit power for at least one first antenna of the one or more antennas based on the change in the sensor data at the first housing satisfying the threshold value, where the first housing includes the at least one first antenna. The device may also maintain or increase a second transmit power for at least one second antenna of the one or more antennas based on the change in the sensor data at the second housing failing to satisfy the threshold value, where the second housing includes the at least one second antenna. That is, if the transmit power for the second antenna is not within a proximity to the user (e.g., does not satisfy the threshold value, is less than the threshold value), then the device maintains or increases the second transmit power. In some other cases, the device reduces the transmit power for the one or more antennas based on the change in the sensor data at the first housing and at the second housing satisfying the threshold value, where the first housing and the second housing include the one or more antennas.

The device may select respective transmit powers for the one or more antennas that satisfy a maximum permissible exposure threshold value associated with the signaling. The device may receive an indication of the maximum permissible exposure threshold value. Additionally, or alternatively, the device may determine, based on the maximum permissible exposure threshold value, a set of threshold values (e.g., including the threshold value) corresponding to the first sensor and the second sensor.

At 606, the device transmits signaling using the transmit power for the one or more antennas.

FIG. 7 illustrates an example method 700 for transmit power management using sensor data in accordance with one or more implementations. The order in which the method is described is not intended to be construed as a limitation, and any number or combination of the described method operations can be performed in any order to perform a method, or an alternate method.

At 702, a device detects a change in sensor data at one or more of the first housing or the second housing using a first sensor of a first housing and a second sensor of a second housing. The device can include a device housing that includes the first housing and the second housing, which is foldably coupled with the first housing. For example, the housings may be foldably coupled by being connected by a hinge or flexible joint that provides for the housings to fold together (e.g., such that one or more edges or surfaces of the housings are touching) or apart (e.g., such that a single edge or fewer or no surface of the housings is touching). The first sensor and the second sensor may include capacitor sensors, and the sensor data may include capacitance values that indicate a proximity of human tissue to at least one of the first housing or the second housing.

In some cases, prior to detecting the change in the sensor data, the device detects that a surface of the device is in contact with a user (e.g., the device is in a body-worn use case). Responsive to the surface of the device being in contact with the user, the device obtains the sensor data.

At 704, the device reduces a first transmit power for at least one first antenna of the first housing based on the change in the sensor data at the first housing satisfying the threshold value.

At 706, the device maintains or increases a second transmit power for at least one second antenna of the second housing based on the change in the sensor data at the second housing failing to satisfy the threshold value.

The device may select respective transmit powers for the one or more antennas that satisfy a maximum permissible exposure threshold value associated with the signaling. The device may receive an indication of the maximum permissible exposure threshold value. Additionally, or alternatively, the device may determine, based on the maximum permissible exposure threshold value, a set of threshold values (e.g., including the threshold value) corresponding to the first sensor and the second sensor.

At 708, the device transmits signaling using the first transmit power for the at least one first antenna and the second transmit power for the at least one second antenna.

The example flowchart 500, the example method 600, and the example method 700, are described with reference to respective FIGS. 5, 6, and 7 in accordance with one or more implementations of transmit power management using sensor data, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 8 illustrates various components of an example device 800, which can implement aspects of the techniques and features for transmit power management using sensor data, as described herein. The example device 800 can be implemented as any of the devices described with reference to the previous FIGS. 1-7, such as any type of a wireless device, mobile device, mobile phone, flip phone, client device, companion device, paired device, display device, tablet, wearable device, computing, communication, entertainment, gaming, media playback, and/or any other type of computing, consumer, and/or electronic device. For example, the device 102, as described with reference to FIGS. 1-7, may be implemented as the example device 800.

The example device 800 can include various, different communication devices 802 that enable wired and/or wireless communication of device data 804 with other devices. The device data 804 can include any of the various device’s data and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers for cellular phone communication and/or for any type of network data communication.

The example device 800 can also include various, different types of data input / output (I/O) interfaces 806, such as data network interfaces that provide connection and/or communication links between the devices, data networks, and other devices. The I/O interfaces 806 can be used to couple the device to any type of components, peripherals, and/or accessory devices, such as a computer input device that may be integrated with the example device 800. The I/O interfaces 806 may also include data input ports via which any type of data, information, media content, communications, messages, and/or inputs can be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a SoC that processes computer-executable instructions. The processor system 808 may be implemented at least partially in computer hardware, which can include components of an integrated circuit or on-chip system, an ASIC, a FPGA, a CPLD, and other implementations in silicon and/or other hardware. Alternatively, or in addition, the device can be implemented with any one or combination of software, hardware, firmware, or fixed logic circuitry that may be implemented in connection with processing and control circuits, which are generally identified as processing and control 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 812 include volatile memory and non‑volatile memory, fixed and removable media devices, and any suitable memory device or electronic data storage that maintains data for computing device access. The memory devices 812 can include various implementations of random-access memory (RAM), read-only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 can be maintained as software instructions with a memory device 812 and executed by the processor system 808 as a software application. The device applications 814 may also include a device manager, such as any form of a control application, software application, signal‑processing and control module, code that is specific to a particular device, a hardware abstraction layer for a particular device, and so on.

In this example, the device 800 includes a communications and data manager 818 that implements various aspects of the described features and techniques described herein. The communications and data manager 818 can be implemented with hardware components and/or in software as one of the device applications 814, such as when the example device 800 is implemented as the device 102 described with reference to FIGS. 1-7. An example of the communications and data manager 818 is the communications manager 122 and/or a data manager of the data in the data storage 124 implemented in the device 102, such as a software application and/or as hardware components in the wireless device. In one or more implementations, the communications and data manager 818 may include independent processing, memory, and logic components as a computing and/or electronic device integrated with the example device 800.

The example device 800 can also include a microphone 820 and/or camera devices 822, as well as proximity and/or motion sensors 824, such as may be implemented as components of an inertial measurement unit (IMU), and geographical location information sensors (e.g., GPS to obtain a current geographic location of the client device or a user of the client device). The proximity and/or motion sensors 824 can be implemented with various sensors 826, such as a gyroscope, an accelerometer, and/or other types of motion sensors to sense motion of the device. The motion sensors 824 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources, such as when the device is implemented as a wireless device and/or a device 102. The power sources may include a charging and/or power system, and can be implemented as a flexible strip battery, a rechargeable battery, a charged super‑capacitor, and/or any other type of active or passive power source.

The example device 800 can also include an audio and/or video processing system 828 that generates audio data for an audio system 830 and/or generates display data for a display system 832. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In one or more implementations, the audio system and/or the display system are integrated components of the example device 800. Alternatively, the audio system and/or the display system are external, peripheral components to the example device.

Although implementations of transmit power management using sensor data have been described in language specific to features and/or methods, the appended claims are not necessarily limited to the specific features or methods described. Rather, the specific features and methods are disclosed as example implementations for transmit power management using sensor data, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a device for wireless communications, the device including at least one memory, a device housing including a first housing and a second housing foldably coupled with the first housing, and at least one processor coupled with the at least one memory and operable to cause the device to detect, using a first sensor of the first housing and a second sensor of the second housing, a change in sensor data at one or more of the first housing or the second housing, determine, based on the change in the sensor data satisfying a threshold value, a transmit power for one or more antennas of the first housing or of the second housing, and transmit signaling using the transmit power for the one or more antennas.

In some aspects, the techniques described herein relate to a device, where to determine the transmit power for the one or more antennas, the at least one processor is operable to cause the device to reduce a first transmit power for at least one first antenna of the one or more antennas based on the change in the sensor data at the first housing satisfying the threshold value, where the first housing includes the at least one first antenna, and maintain or increase a second transmit power for at least one second antenna of the one or more antennas based on the change in the sensor data at the second housing failing to satisfy the threshold value, where the second housing includes the at least one second antenna.

In some aspects, the techniques described herein relate to a device, where to determine the transmit power for the one or more antennas, the at least one processor is further operable to cause the device to reduce the transmit power for the one or more antennas based on the change in the sensor data at the first housing and at the second housing satisfying the threshold value, where the first housing and the second housing include the one or more antennas.

In some aspects, the techniques described herein relate to a device, where the at least one processor is further operable to cause the device to detect, prior to detecting the change in the sensor data, a surface of the device is in contact with a user, and obtain, responsive to the surface of the device being in contact with the user, the sensor data.

In some aspects, the techniques described herein relate to a device, where to determine the transmit power for the one or more antennas, the at least one processor is operable to cause the device to select respective transmit powers for the one or more antennas that satisfy a maximum permissible exposure threshold value associated with the signaling.

In some aspects, the techniques described herein relate to a device, where the at least one processor is further operable to cause the device to receive an indication of the maximum permissible exposure threshold value.

In some aspects, the techniques described herein relate to a device, where the at least one processor is further operable to cause the device to determine, based on the maximum permissible exposure threshold value, a set of threshold values corresponding to the first sensor and the second sensor, where the set of threshold values include the threshold value.

In some aspects, the techniques described herein relate to a device, where the first sensor and the second sensor include capacitor sensors, and where the sensor data includes capacitance values that indicate a proximity of human tissue to at least one of the first housing or the second housing.

In some aspects, the techniques described herein relate to a method performed by a device, the method including detecting, using a first sensor of a first housing of the device and a second sensor of a second housing of the device, a change in sensor data at one or more of the first housing of the device or the second housing of the device, where the first housing of the device is foldably coupled with the second housing of the device, determining, based on the change in the sensor data satisfying a threshold value, a transmit power for one or more antennas of the first housing of the device or of the second housing of the device, and transmitting signaling using the transmit power for the one or more antennas.

In some aspects, the techniques described herein relate to a method, where determining the transmit power for the one or more antennas includes reducing a first transmit power for at least one first antenna of the one or more antennas based on the change in the sensor data at the first housing of the device satisfying the threshold value, where the first housing of the device includes the at least one first antenna, and maintaining or increasing a second transmit power for at least one second antenna of the one or more antennas based on the change in the sensor data at the second housing of the device failing to satisfy the threshold value, where the second housing of the device includes the at least one second antenna.

In some aspects, the techniques described herein relate to a method, where determining the transmit power for the one or more antennas includes reducing the transmit power for the one or more antennas based on the change in the sensor data at the first housing of the device and at the second housing of the device satisfying the threshold value, where the first housing of the device and the second housing of the device include the one or more antennas.

In some aspects, the techniques described herein relate to a method, further including detecting, prior to detecting the change in the sensor data, a surface of the device is in contact with a user, and obtaining, responsive to the surface of the device being in contact with the user, the sensor data.

In some aspects, the techniques described herein relate to a method, where determining the transmit power for the one or more antennas includes selecting respective transmit powers for the one or more antennas that satisfy a maximum permissible exposure threshold value associated with the signaling.

In some aspects, the techniques described herein relate to a method, where the first sensor and the second sensor include capacitor sensors, and where the sensor data includes capacitance values that indicate a proximity of human tissue to at least one of the first housing of the device or the second housing of the device.

In some aspects, the techniques described herein relate to a system, including a first housing integrated with a first sensor, a second housing integrated with a second sensor, where the second housing is foldably coupled with the first housing, and a communications manager to detect, using the first sensor and the second sensor, a change in sensor data at one or more of the first housing or the second housing, determine, based on the change in the sensor data satisfying a threshold value, a transmit power for one or more antennas of the first housing or of the second housing, and transmit signaling using the transmit power for the one or more antennas.

In some aspects, the techniques described herein relate to a system, where to determine the transmit power for the one or more antennas, the communications manager is configured to reduce a first transmit power for at least one first antenna of the one or more antennas based on the change in the sensor data at the first housing satisfying the threshold value, where the first housing includes the at least one first antenna, and maintain or increase a second transmit power for at least one second antenna of the one or more antennas based on the change in the sensor data at the second housing failing to satisfy the threshold value, where the second housing includes the at least one second antenna.

In some aspects, the techniques described herein relate to a system, where to determine the transmit power for the one or more antennas, the communications manager is configured to reduce the transmit power for the one or more antennas based on the change in the sensor data at the first housing and at the second housing satisfying the threshold value, where the first housing and the second housing include the one or more antennas.

In some aspects, the techniques described herein relate to a system, where the communications manager is further configured to detect, prior to detecting the change in the sensor data, a surface of at least one of the first housing or the second housing is in contact with a user, and obtain, responsive to the surface being in contact with the user, the sensor data.

In some aspects, the techniques described herein relate to a system, where to determine the transmit power for the one or more antennas, the communications manager is configured to select respective transmit powers for the one or more antennas that satisfy a maximum permissible exposure threshold value associated with the signaling.

In some aspects, the techniques described herein relate to a system, where the first sensor and the second sensor include capacitor sensors, and where the sensor data includes capacitance values that indicate a proximity of human tissue to at least one of the first housing or the second housing.

What is Claimed is:

1. A device for wireless communications, the device comprising:
at least one memory;
a device housing comprising a first housing and a second housing foldably coupled with the first housing; and
at least one processor coupled with the at least one memory and operable to cause the device to:
detect, using a first sensor of the first housing and a second sensor of the second housing, a change in sensor data at one or more of the first housing or the second housing;
determine, based at least in part on the change in the sensor data satisfying a threshold value, a transmit power for one or more antennas of the first housing or of the second housing; and
transmit signaling using the transmit power for the one or more antennas.

2. The device of claim 1, wherein to determine the transmit power for the one or more antennas, the at least one processor is operable to cause the device to:
reduce a first transmit power for at least one first antenna of the one or more antennas based at least in part on the change in the sensor data at the first housing satisfying the threshold value, wherein the first housing comprises the at least one first antenna; and
maintain or increase a second transmit power for at least one second antenna of the one or more antennas based at least in part on the change in the sensor data at the second housing failing to satisfy the threshold value, wherein the second housing comprises the at least one second antenna.

3. The device of claim 1, wherein to determine the transmit power for the one or more antennas, the at least one processor is further operable to cause the device to reduce the transmit power for the one or more antennas based at least in part on the change in the sensor data at the first housing and at the second housing satisfying the threshold value, wherein the first housing and the second housing comprise the one or more antennas.

4. The device of claim 1, wherein the at least one processor is further operable to cause the device to:
detect, prior to detecting the change in the sensor data, a surface of the device is in contact with a user; and
obtain, responsive to the surface of the device being in contact with the user, the sensor data.

5. The device of claim 1, wherein to determine the transmit power for the one or more antennas, the at least one processor is operable to cause the device to select respective transmit powers for the one or more antennas that satisfy a maximum permissible exposure threshold value associated with the signaling.

6. The device of claim 5, wherein the at least one processor is further operable to cause the device to receive an indication of the maximum permissible exposure threshold value.

7. The device of claim 5, wherein the at least one processor is further operable to cause the device to determine, based at least in part on the maximum permissible exposure threshold value, a plurality of threshold values corresponding to the first sensor and the second sensor, wherein the plurality of threshold values comprise the threshold value.

8. The device of claim 1, wherein the first sensor and the second sensor comprise capacitor sensors, and wherein the sensor data comprises capacitance values that indicate a proximity of human tissue to at least one of the first housing or the second housing.

9. A method performed by a device, the method comprising:
detecting, using a first sensor of a first housing of the device and a second sensor of a second housing of the device, a change in sensor data at one or more of the first housing of the device or the second housing of the device, wherein the first housing of the device is foldably coupled with the second housing of the device;
determining, based at least in part on the change in the sensor data satisfying a threshold value, a transmit power for one or more antennas of the first housing of the device or of the second housing of the device; and
transmitting signaling using the transmit power for the one or more antennas.

10. The method of claim 9, wherein determining the transmit power for the one or more antennas comprises:
reducing a first transmit power for at least one first antenna of the one or more antennas based at least in part on the change in the sensor data at the first housing of the device satisfying the threshold value, wherein the first housing of the device comprises the at least one first antenna; and
maintaining or increasing a second transmit power for at least one second antenna of the one or more antennas based at least in part on the change in the sensor data at the second housing of the device failing to satisfy the threshold value, wherein the second housing of the device comprises the at least one second antenna.

11. The method of claim 9, wherein determining the transmit power for the one or more antennas comprises reducing the transmit power for the one or more antennas based at least in part on the change in the sensor data at the first housing of the device and at the second housing of the device satisfying the threshold value, wherein the first housing of the device and the second housing of the device comprise the one or more antennas.

12. The method of claim 9, further comprising:
detecting, prior to detecting the change in the sensor data, a surface of the device is in contact with a user; and
obtaining, responsive to the surface of the device being in contact with the user, the sensor data.

13. The method of claim 9, wherein determining the transmit power for the one or more antennas comprises selecting respective transmit powers for the one or more antennas that satisfy a maximum permissible exposure threshold value associated with the signaling.

14. The method of claim 9, wherein the first sensor and the second sensor comprise capacitor sensors, and wherein the sensor data comprises capacitance values that indicate a proximity of human tissue to at least one of the first housing of the device or the second housing of the device.

15. A system, comprising:
a first housing integrated with a first sensor;
a second housing integrated with a second sensor, wherein the second housing is foldably coupled with the first housing; and
a communications manager to:
detect, using the first sensor and the second sensor, a change in sensor data at one or more of the first housing or the second housing;
determine, based at least in part on the change in the sensor data satisfying a threshold value, a transmit power for one or more antennas of the first housing or of the second housing; and
transmit signaling using the transmit power for the one or more antennas.

16. The system of claim 15, wherein to determine the transmit power for the one or more antennas, the communications manager is configured to:
reduce a first transmit power for at least one first antenna of the one or more antennas based at least in part on the change in the sensor data at the first housing satisfying the threshold value, wherein the first housing comprises the at least one first antenna; and
maintain or increase a second transmit power for at least one second antenna of the one or more antennas based at least in part on the change in the sensor data at the second housing failing to satisfy the threshold value, wherein the second housing comprises the at least one second antenna.

17. The system of claim 15, wherein to determine the transmit power for the one or more antennas, the communications manager is configured to reduce the transmit power for the one or more antennas based at least in part on the change in the sensor data at the first housing and at the second housing satisfying the threshold value, wherein the first housing and the second housing comprise the one or more antennas.

18. The system of claim 15, wherein the communications manager is further configured to:
detect, prior to detecting the change in the sensor data, a surface of at least one of the first housing or the second housing is in contact with a user; and
obtain, responsive to the surface being in contact with the user, the sensor data.

19. The system of claim 15, wherein to determine the transmit power for the one or more antennas, the communications manager is configured to select respective transmit powers for the one or more antennas that satisfy a maximum permissible exposure threshold value associated with the signaling.

20. The system of claim 15, wherein the first sensor and the second sensor comprise capacitor sensors, and wherein the sensor data comprises capacitance values that indicate a proximity of human tissue to at least one of the first housing or the second housing.
